(19) United States
(12) Patent Application Publication
(10) Pub. No.: US 2014/0052426 A1
(43) Pub. Date: Feb. 20, 2014

(54) SYSTEM AND METHOD TO MANAGE CONDENSATE FORMATION

(71) Applicants: Achalesh Kumar Pandey, Greenville, SC (US); Kelvin Rafael Estrada, Norcross, GA (US); Niranjan Gokuldas Pai, Clifton Park, NY (US)

(72) Inventors: Achalesh Kumar Pandey, Greenville, SC (US); Kelvin Rafael Estrada, Norcross, GA (US); Niranjan Gokuldas Pai, Clifton Park, NY (US)

(73) Assignee: GENERAL ELECTRIC COMPANY, Schenectady, NY (US)

(21) Appl. No.: 13/585,342

(22) Filed: Aug. 14, 2012

(51) Int. Cl. G06G 7/48

(52) U.S. Cl. 703/6

(57) ABSTRACT

A system and method control condensate formation within headers of a heat recovery steam generator (HRSG) in a power generation facility. The system includes measurement devices to measure first parameters including pressure at respective first locations within the power generation facility. A model estimates second parameters at second locations within the power generation facility. A prediction model outputs a prediction of time of condensate formation on each of the headers based on the first parameters and the second parameters, and a controller controls the condensate formation based on the prediction.

### BACKGROUND OF THE INVENTION

The subject matter disclosed herein relates to reducing thermal stresses in a heat recovery steam generator (HRSG).

In a combined cycle power plant, waste heat from a gas turbine is used by a heat recovery steam generator (HRSG) to generate steam for operation of the steam turbine. Because of the large thickness of the HRSG header pipes, a temperature gradient can form across the thickness of a header pipe when condensate forms on the inside of the headers, cooling the inner metal while the middle and outer metals remain hotter. This temperature gradient creates thermal stresses that reduce the life of the headers. Prior art HRSG systems have tried to control the temperature gradient by opening the drains and vents of the HRSG using rule-based or timed control. However, these prior controls are not effective. Thus, systems and methods to monitor and control condensate formation to mitigate the temperature gradient effect would be appreciated in the power generation industry.

### BRIEF DESCRIPTION OF THE INVENTION

According to an aspect of the invention, a system to control condensate formation within headers of a heat recovery steam generator (HRSG) in a power generation facility includes measurement devices configured to measure first parameters including pressure at respective first locations within the power generation facility; a model configured to estimate second parameters at second locations within the power generation facility; a prediction model configured to output a prediction of time of condensate formation on each of the headers based on the first parameters and the second parameters; and a controller configured to control the condensate formation based on the prediction.

According to another aspect of the invention, a method to control condensate formation within headers of a heat recovery steam generator (HRSG) in a power generation facility includes measuring parameters including steam temperature at respective first locations within the power generation facility; estimating thermodynamic characteristics within the headers of the HRSG; predicting time of condensate formation for each header of the HRSG based on the parameters and the thermodynamic characteristics obtained from the measuring and the estimating; and controlling the condensate formation to prevent or reduce the condensate formation predicted by the predicting.

According to yet another aspect of the invention, a computer-readable medium stores instructions that, when processed by a processor, cause the processor to implement a method to control condensate formation within headers of a heat recovery steam generator (HRSG) in a power generation facility. The method includes receiving first parameters including steam temperature measured at respective first locations within the power generation facility; estimating thermodynamic characteristics within the headers of the HRSG; predicting time of condensate formation for each header of the HRSG based on the parameters and the thermodynamic characteristics obtained from the measuring and the estimating; and controlling the condensate formation to prevent or reduce the condensate formation predicted by the predicting.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of exemplary components of a combined cycle power plant;

FIG. 2 depicts aspects of an exemplary bottom header of the HRSG;

FIG. 3 depicts aspects of an exemplary top header of the HRSG;

FIG. 4 is a block diagram of a control system to control condensate formation according to embodiments of the invention; and

FIG. 5 depicts processes involved in controlling condensate formation according to embodiments of the invention.

The detailed description explains embodiments of the invention, together with advantages and features, by way of example with reference to the drawings.

### DETAILED DESCRIPTION OF THE INVENTION

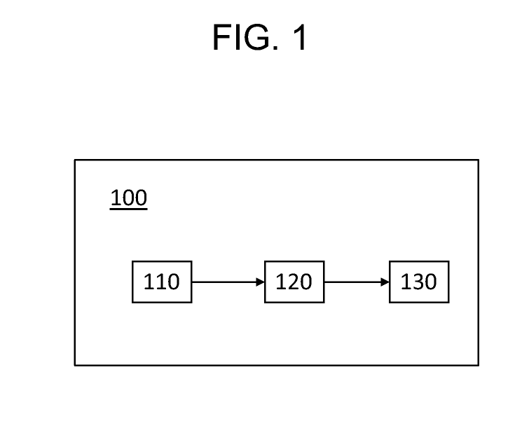

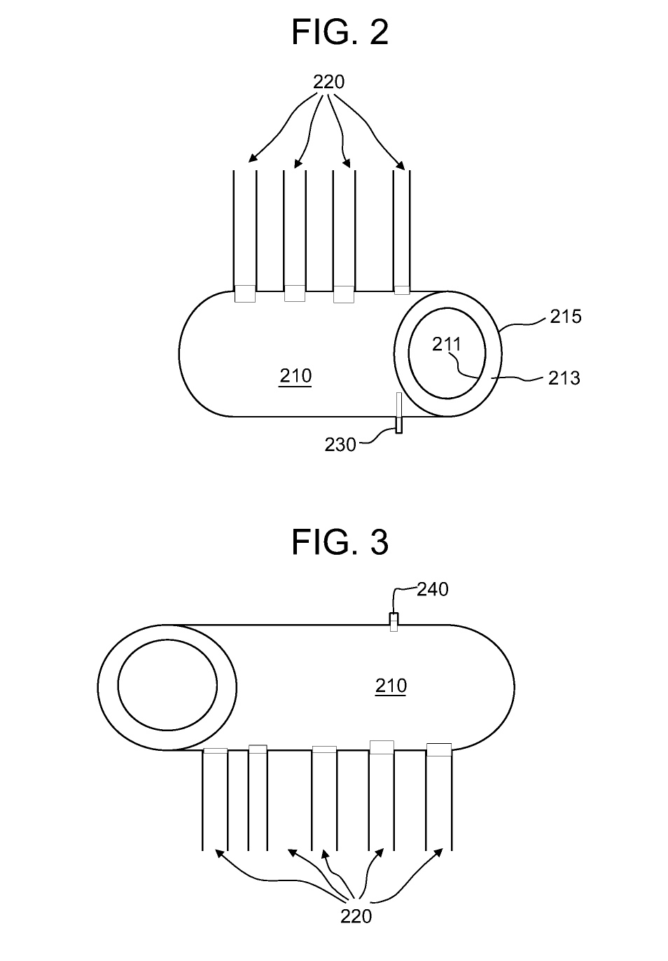

FIG. 1 is a block diagram of exemplary components of a combined cycle power plant 100. The combined cycle power plant 100 includes at least a gas turbine 110 and a steam turbine 130. A heat recovery steam generator (HRSG) 120 uses waste heat of the gas turbine 110 to generate steam that it supplies to the steam turbine 130. The HRSG 120 includes headers 210 (FIGS. 2 and 3) that act as main collection/distribution channels for steam and water.

FIG. 2 depicts aspects of an exemplary bottom header 210 of the HRSG 120. The bottom header 210 is fed by tubes 220 and includes a drain 230 to drain water that collects in the bottom header 210. In alternate embodiments, the drain 230 may be part of one or more tubes 220 rather than included on the header 210. A header 210 is comprised of thick metal and can be thought of as having an inner-wall 211, a mid-wall 213, and an outer-wall 215. It is due to this thickness of the metal comprising the headers 210 that a temperature gradient can form across the inner-wall 211, mid-wall 213, and outer-wall 215 when (cooler) condensate forms within a header 210 against the inner-wall 211 while the outer-wall 215 remains extremely hot. The temperature gradient has the adverse effect of causing thermal stress in the metal of the headers 210 and reducing their fatigue life.

FIG. 3 depicts aspects of an exemplary top header 210 of the HRSG 120. The top header 210 supplies tubes 220 and includes a vent 240 for steam. In alternate embodiments, the vent 240 may be part of one or more tubes 220 rather than included on the header 210. The drains 230 and vents 240 of the headers 210 are important for controlling condensate and for efficient operation of the HRSG 120. The drains 230 are important for draining water within the headers 210 and preventing corrosion of the metal comprising the headers 210. The drains 230 also serve to clear out water from areas of the HRSG 120 that should only have dry steam. For example, draining of water and condensate avoids water hammer events during startups. The vents 240 release steam or displace air trapped at startup. The drains 230 and vents 240 are operated at various times during startup, shutdown, and in transient states. As noted above, in prior art systems, the operation of drains 230 and vents 240 has not been based on a prognostic determination of condensate formation.

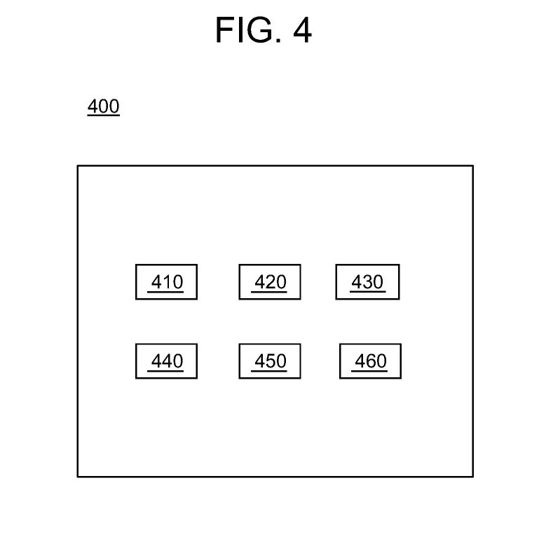

FIG. 4 is a block diagram of a control system 400 to control condensate formation according to embodiments of the invention. The measurement devices 410 include measurement devices and sensors that collect data from different parts of the combined cycle power plant 100. These measurement devices 410 collect information that may include steam temperatures, gas temperatures, HRSG 120 pressure, and turbine speed over time. The processor 420 may represent one or more processors and memory devices that work together to process the information obtained by the measurement devices 410 and generated by the models 430, 440, 450 to instruct the controller 460 on how to operate drains 230 and vents 240 as needed to control condensate formation. The processor 420 determines the operating mode based on information from the measurement devices 410. Based on the mode determination, condensate formation may need to be controlled. That is, the control system 400 uses the output of the models 430, 440, 450 to control condensate formation when the processor 420 determines that the operating mode is the startup mode.

Each of the models 430, 440, 450 may include one or more processors and memory devices themselves. Although shown and discussed separately for ease of understanding, some or many of the components of the control system 400 may be implemented by a collection of processors and memory devices. The thermodynamic model 430 provides metal temperatures of each of the headers 210 of the HRSG 120. The thermodynamic model 430 estimates parameters for locations within the combined cycle power plant 100 (e.g., HRSG 120) that do not include measurement devices 410. Temperature and pressure information is only available at a few locations in the HRSG 120 (e.g., at final super heater outlet), but there are several headers in the HRSG 120 without any sensors. The thermodynamic model 430 is used to estimate steam properties at those locations. The temperature and pressure values are used by the condensate formation prediction model 440 to predict when condensate will form in each header 210. The information provided by the condensate formation prediction model 440 may be used to control the drains 230 and vents 240 or to otherwise control condensate formation in different ways, each of which is detailed below. The controller 460 outputs the control signal from the control system 400 to carry out each form of control. The controller may additionally use information from the virtual sensor model 450. The virtual sensor model 450 uses information from the measurement devices 410 and from the thermodynamic model 430 to estimate metal temperature of each of the headers 210 at the inner-wall 211, mid-wall 213, and outer wall 215 and pressure within the headers 210. Thus, while the thermodynamic model 430 generates temperature and pressure values that are used by the condensate formation prediction model 440 to predict when condensate will form, the virtual sensor model 450 quantifies the effect of that condensate formation for the controller 460 (quantifies the thermal gradient) to enhance the decision-making process of the controller 460 regarding when and how much to control condensate formation.

In one embodiment, the control system 400 prevents condensate formation altogether. This is accomplished by reducing the duration of the purge cycle of the gas turbine 110 as needed based on the predicted time of formation of condensate by the condensate formation prediction model 440. That is, the purge cycle is controlled to end prior to the time when condensate is predicted to begin forming. The reduction in the duration of the purge cycle may be accomplished with a control signal output by the controller 460 to the gas turbine 110 controller. The reduction in the duration of the purge cycle has the effect of less cool air being drawn into the combined cycle power plant 100 that could condense trapped steam. This scenario takes advantage of the prognostic features of the condensate formation prediction model 440.

In alternate embodiments, the control system 400 controller 460 outputs one or more control signals to operate drains 230 and vents 240 of the headers 210 to mitigate condensate formation. One of these embodiments involves monitoring the metal temperature of the headers 210 as estimated by the thermodynamic model 430. Any of the temperatures (inner-wall 211, mid-wall 213, or outer-wall 215) may be used. When the rate of change of a difference in the temperature exceeds a threshold value (e.g., a value that indicates the onset of condensate formation), the controller 460 controls the drains 230 and vents 240 to reduce or eliminate the condensate and, thereby, control the temperature gradient across the metal of the headers 210. Another embodiment involves monitoring the surface metal temperature of one or more headers 210 using a thermocouple (one per header), which may be, for example, one of the measurement devices 410. When the temperature of the one or more monitored headers changes at a rate that exceeds a threshold value (e.g., a value that indicates the onset of condensate formation), the controller 460 controls the drains 230 and vents 240 to reduce or eliminate the condensate and, thereby, control the temperature gradient across the metal of the headers 210.

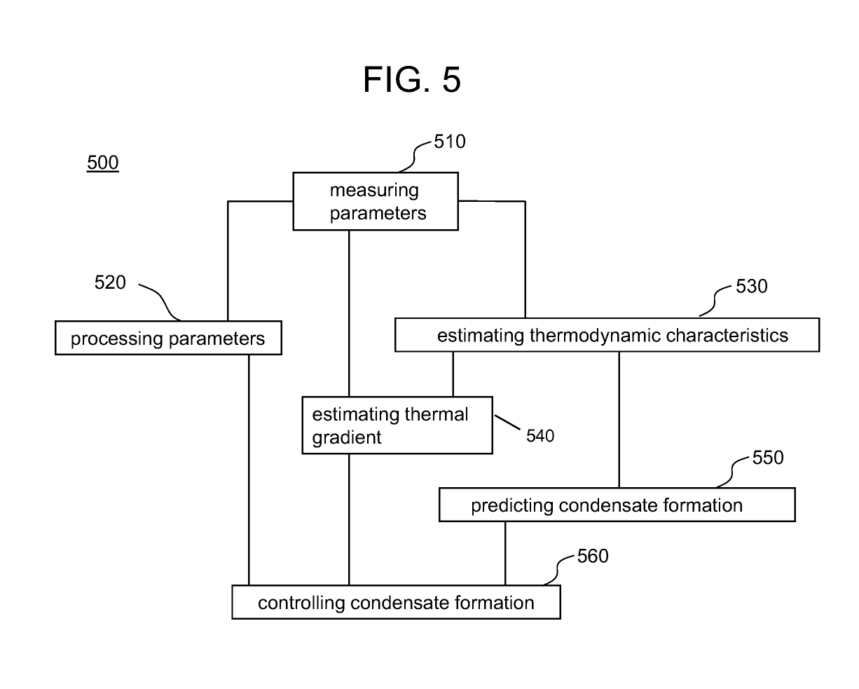

FIG. 5 depicts processes 500 involved in controlling condensate formation according to embodiments of the invention. The processes 500 include measuring parameters at 510 at different locations within the combined cycle power plant 100. The parameters may include steam temperature, gas temperature, HRSG 120 pressure, mass flow rate of exhaust gas, and turbine speed recorded by various measurement devices 410. Processing the parameters at 520 includes determining a mode of operation and, specifically, determining whether the operating mode is the startup mode during which condensate formation must be controlled. Estimating thermodynamic characteristics at 530 includes using a thermodynamic model 430 to estimate parameters for locations within the combined cycle power plant 100 (e.g., HRSG 120) that do not include measurement devices 410. Estimating thermal gradient at 540 includes using the virtual sensor model 450 and using the measured parameters and estimated parameters (at block 530) to estimate the metal temperature of each of the headers 210 at the inner-wall 211, mid-wall 213, and outer wall 215 and pressure within the headers 210. The processes 500 include predicting condensate formation with the condensate formation prediction model 440 at 550. Predicting condensate formation includes predicting when condensate will form in each header 210 using output from the thermodynamic model 430 at the condensate formation prediction model 440. At 560, controlling condensate formation may be by one of the embodiments discussed above or by an alternate embodiment that prevents or mitigates condensate formation based on the predicted time of condensate formation. Controlling condensate formation with the controller 460 includes using the predicted time of condensate formation (based on the thermodynamic model 430 and condensate formation prediction model 440) and may additionally include using the virtual sensor model 450 to better determine control by having a quantitative measure of the effect of condensation.

As noted previously, each of the models 430, 440 may be implemented by one or more processors and one or more memory devices. In addition, the processor 420 and controller 450 may be implemented by the same or additional processors and memory devices. The control system 400 has the technical effect of preventing or reducing condensate formation and, thereby, reducing the thermal stresses caused by high temperature gradients across the metal of the headers 210.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system to manage condensate formation within headers of a heat recovery steam generator (HRSG) in a power generation facility, the system comprising:
measurement devices configured to measure first parameters including pressure at respective first locations within the power generation facility;
a model configured to estimate second parameters at second locations within the power generation facility;
a prediction model configured to output a prediction of time of condensate formation on each of the headers based on the first parameters and the second parameters; and
a controller configured to manage the condensate formation based on the prediction.

2. The system according to claim 1, wherein the measurement devices additionally measure at least one of gas temperature, HRSG pressure, mass flow rate of gas, turbine speed, or gas turbine non-running hours.

3. The system according to claim 1, wherein the model includes a thermodynamic model configured to estimate metal temperatures of the headers of the HRSG.

4. The system according to claim 1, wherein the controller controls opening and closing of drains and vents of the HRSG based on the prediction of time of condensate formation.

5. The system according to claim 1, further comprising a second model configured to estimate metal temperatures at inner, middle, and outer walls of the headers of the HRSG.

6. The system according to claim 5, wherein the controller controls opening and closing of drains and vents of the HRSG to prevent or reduce condensate formation based on an estimated rate of change of the inner, middle, or outer wall temperature of at least one of the headers exceeding a threshold value.

7. The system according to claim 1, further comprising a processor configured to identify a mode of operation of the power generation facility.

8. The system according to claim 7, wherein the controller manages the condensate formation when the processor identifies the mode of operation as a startup mode.

9. The system according to claim 1, wherein the controller prevents condensate formation by reducing a purge cycle of a gas turbine supplying heat to the HRSG based on the prediction of time of condensate formation.

10. The system according to claim 1, wherein the first parameters include surface metal temperatures of the headers, and the controller controls opening and closing of drains and vents of the HRSG to prevent or reduce condensate formation based on a rate of change of a surface metal temperature of at least one of the headers exceeding a threshold value.

11. A method to manage condensate formation within headers of a heat recovery steam generator (HRSG) in a power generation facility, the method comprising:
measuring parameters including pressure at respective first locations within the power generation facility;
estimating thermodynamic characteristics within the headers of the HRSG;
predicting time of condensate formation for each header of the HRSG based on the parameters and the thermodynamic characteristics obtained from the measuring and the estimating; and
managing the condensate formation to prevent or reduce the condensate formation predicted by the predicting.

12. The method according to claim 11, wherein the measuring includes measuring at least one of gas temperature, HRSG pressure, turbine speed, or gas turbine non-running hours.

13. The method according to claim 11, further comprising estimating metal temperatures at inner, middle, and outer walls of the headers of the HRSG.

14. The method according to claim 13, wherein the controlling includes opening and closing of drains and vents of the HRSG to prevent or reduce the condensate formation based on an estimated rate of change of the inner, middle, or outer wall temperature of at least one of the headers exceeding a threshold value.

15. The method according to claim 11, further comprising processing the parameters and the thermodynamic characteristics obtained from the measuring and the estimating to determine a mode of operation of the power generation facility, wherein the managing is performed when the power generation facility is in a startup mode.

16. The method according to claim 11, wherein the managing includes preventing the condensate formation by reducing a purge cycle of a gas turbine supplying heat to the HRSG based on the time of condensate formation predicted by the predicting.

17. The method according to claim 11, wherein the measuring includes measuring surface metal temperatures of the headers, and the managing includes controlling opening and closing of drains and vents of the HRSG to prevent or reduce the condensate formation based on a rate of change of a surface metal temperature or rate of change or pressure of at least one of the headers exceeding a threshold value.

18. A computer-readable medium configured to store instructions which, when processed by a processor, cause the processor to implement a method to manage condensate formation within headers of a heat recovery steam generator (HRSG) in a power generation facility, the method comprising:
receiving parameters including pressure measured at respective first locations within the power generation facility;
estimating thermodynamic characteristics within the headers of the HRSG;
predicting time of condensate formation for each header of the HRSG based on the parameters and the thermodynamic characteristics obtained from the measuring and the estimating; and
managing the condensate formation to prevent or reduce the condensate formation predicted by the predicting.

19. The computer-readable medium according to claim 18, wherein the managing includes preventing the condensate formation by reducing a purge cycle of a gas turbine supplying heat to the HRSG based on the time of condensate formation predicted by the predicting.

20. The computer-readable medium according to claim 18, wherein the managing includes controlling opening and closing of drains and vents of the HRSG to prevent or reduce the condensate formation.
